(19) United States
(12) Patent Application Publication
(10) Pub. No.: US 2005/0223607 A1
(43) Pub. Date: Oct. 13, 2005

(54) PICTURE HOLDER CAPABLE OF HOLDING PICTURES POSTS OR PHOTOS

(76) Inventor: Hen An Chou, Chong Ho City (TW)

Correspondence Address: Hen An CHOU, P.O. Box 10-69, Chong Ho,, Taipei, 235, TW

(21) Appl. No.: 10/821,598

(22) Filed: Apr. 8, 2004

(51) Int. Cl. G09F 7/00

(52) U.S. Cl. 40/492

(57) ABSTRACT

A picture holder includes a supporting device having two downwardly and outwardly extended flaps, and an upper panel coupled between upper portions of the flaps, to form an inverted U-shaped and stable supporting structure. A loose-leaf binder device is engaged onto and secured to the upper panel of the supporting device, and includes two or more binder rings for detachably attaching photos, and for allowing the pictures or the posts or the photos to be easily changed with each other. The pictures or the posts or the photos may be displayed and seen from both sides of the picture holder.

### BACKGROUND OF THE INVENTION

1. Field of the Invention

The present invention relates to a picture holder, and more particularly to a picture holder having a stable supporting structure and having an easily and quickly photo changing structure.

2. Description of the Prior Art

Typical picture holders comprise a frame to receive and enclose a single picture or a post or photo therein.

For example, U.S. Pat. No. 3,102,351 to Howell discloses one of the typical picture holders comprising a frame formed by a number of frame members that are required to be secured together with fasteners. For inserting and disengaging the pictures or the posts or the photos from the frame, it is required to unthread a number of fasteners to disassemble the frame members from each other, and then to thread the fasteners again, to assemble the frame members together again, such that it may take a long time to change the pictures or the posts or the photos.

U.S. Pat. No. 3,613,280 to Tuchinsky et al. discloses another typical picture holder comprising a frame also formed by a number of frame members that are required to be secured together with fasteners, and a number of spring blades to engage with and to retain the pictures or the posts or the photos in the frame. However, it may also take a long time to disassemble the frame members from each other, and then to assemble the frame members together again, in order to change the pictures or the posts or the photos.

U.S. Pat. No. 3,921,322 to Sharp discloses a further typical picture holder comprising a frame having a number of openings formed therein to selectively or changeably receiving and retaining pictures or photos therein. However, the pictures or the photos may only be seen from one side of the frame.

In addition, the typical picture holders comprise a foldable easel-providing member for supporting the picture holders, and to display the pictures or the posts or the photos. However, the typical picture holders may not be stably supported in place by the foldable easel-providing member, and may be easily collapsed or may easily fall.

The present invention has arisen to mitigate and/or obviate the afore-described disadvantages of the conventional picture holders.

### SUMMARY OF THE INVENTION

The primary objective of the present invention is to provide a picture holder including a stable supporting structure for stably supporting the picture holder in place and for preventing the picture holder from being collapsed or from falling.

The other objective of the present invention is to provide a picture holder including an easily and quickly photo changing structure for allowing the pictures or the posts or the photos to be easily changed with each other.

The further objective of the present invention is to provide a picture holder including a supporting structure for allowing the pictures or the posts or the photos to be displayed and seen from both sides of the picture holder.

In accordance with one aspect of the invention, there is provided a picture holder comprising a supporting device including two downwardly and outwardly extended flaps, and an upper panel coupled between upper portions of the flaps, to form an inverted U-shaped stable supporting structure, and a loose-leaf binder device engaged onto and secured to the upper panel of the supporting device, and including at least two binder rings provided thereon, for detachably attaching photos thereon. The U-shaped stable supporting structure of the supporting device may stably support the picture holder in place and may prevent the picture holder from being collapsed or from falling. In addition, the loose-leaf binder device allows the pictures or the posts or the photos to be easily changed with each other. Furthermore, the pictures or the posts or the photos to be displayed and seen from both sides of the picture holder.

The loose-leaf binder device is secured to the upper panel of the supporting device with fasteners.

Further objectives and advantages of the present invention will become apparent from a careful reading of the detailed description provided hereinbelow, with appropriate reference to the accompanying drawings.

### BRIEF DESCRIPTION OF THE DRAWINGS

FIG. 1 is a perspective view of a picture holder in accordance with the present invention;

FIG. 2 is an exploded view of the picture holder;

FIG. 3 is a partial exploded view illustrating the operation of the picture holder; and

FIG. 4 is a perspective view illustrating the operation of the picture holder.

### DETAILED DESCRIPTION OF THE PREFERRED EMBODIMENT

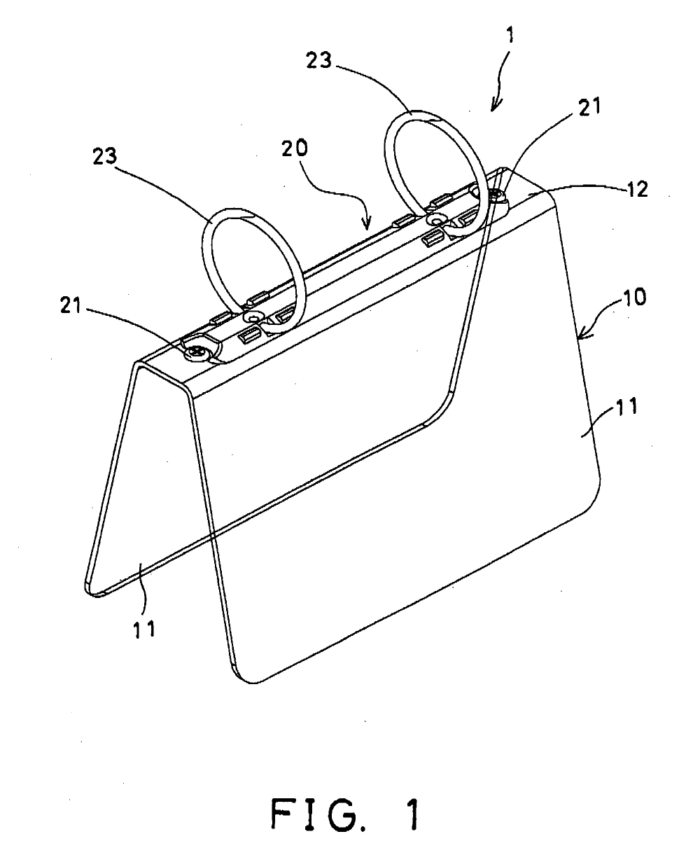

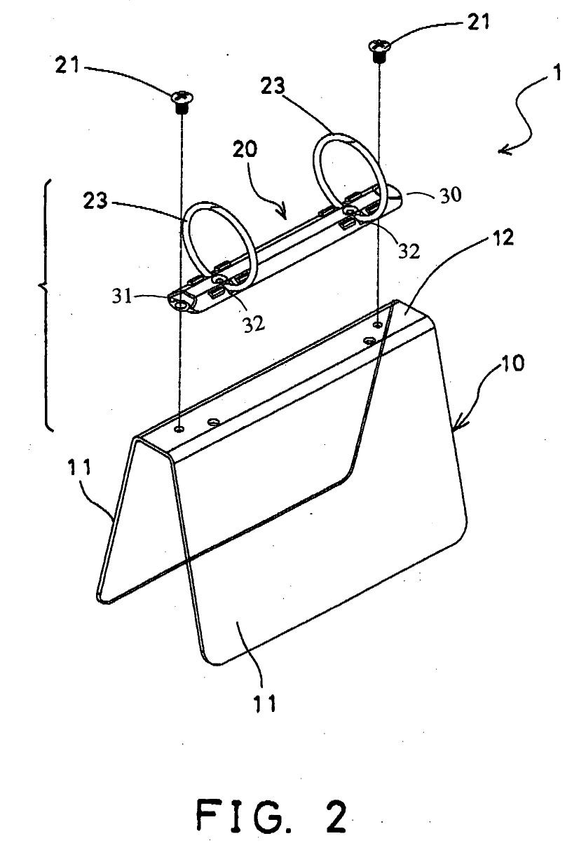

Referring to the drawings, and initially to FIGS. 1 and 2, a picture holder 1 in accordance with the present invention comprises a stable supporting device 10 including two downwardly and outwardly extended flaps 11, and an upper panel 12 provided or coupled between the upper portions of the flaps 11, to form a substantially inverted U-shaped stable supporting structure.

The picture holder 1 further includes a loose-leaf binder device 20 engaged onto the upper panel 12 of the supporting device 10, and secured to the upper panel 12 of the supporting device 10 with fasteners 21. The loose-leaf binder device 20 includes one or more, such as two binder rings 23 provided thereon, for detachably or changeably attaching or securing pictures or posts or photos 3 thereon.

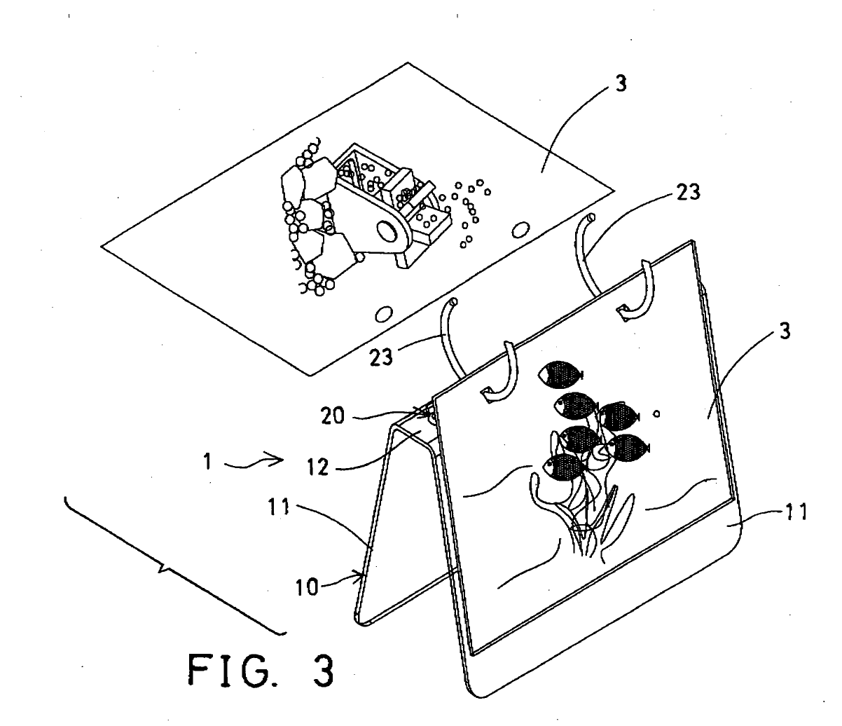

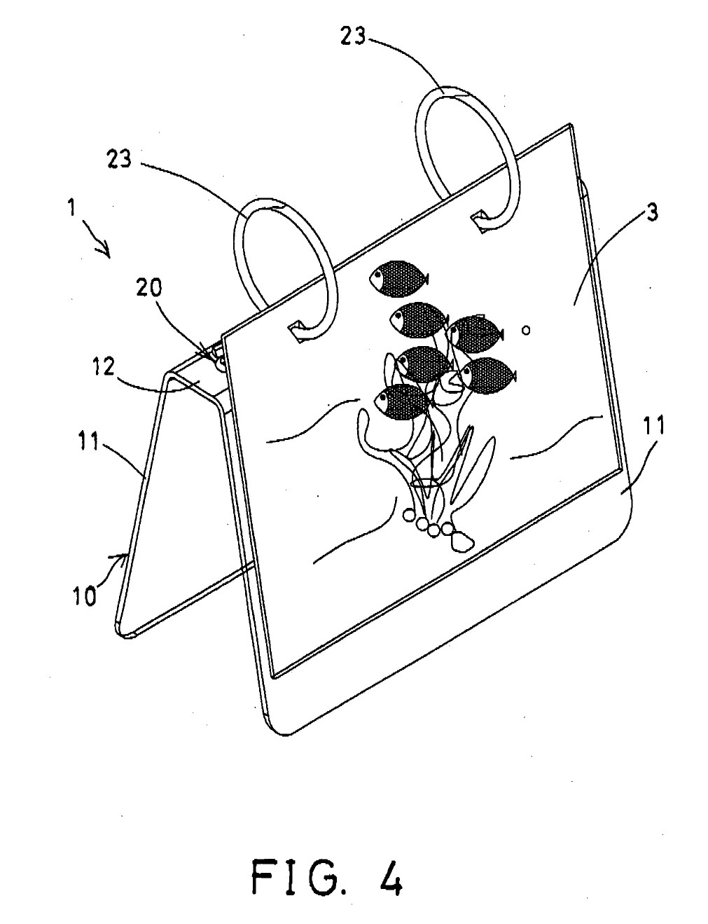

As shown in FIGS. 3 and 4, one or more pictures or posts or photos 3 may be easily and quickly and detachably or changeably attached or secured onto the picture holder 1 with the loose-leaf binder device 20, for allowing the pictures or the posts or the photos 3 to be easily changed with each other or to be changed with the other ones.

In addition, as shown in FIG. 3, two of the pictures or the posts or the photos 3 may be engaged onto the downwardly and outwardly extended flaps 11, and may thus be displayed and seen from both sides of the picture holder 1. It is to be noted that the loose-leaf binder device 20 is engaged onto and secured on the upper panel 12 of the supporting device 10, such that the pictures or the posts or the photos 3 may be engaged onto the flaps 11, and may thus be displayed and seen from both sides of the picture holder 1.

Accordingly, the picture holder in accordance with the present invention includes a stable supporting structure for stably supporting the picture holder in place and for preventing the picture holder from being collapsed or from falling, and/or includes an easily and quickly photo changing structure for allowing the pictures or the posts or the photos to be easily changed with each other, and/or includes a supporting structure for allowing the pictures or the posts or the photos to be displayed and seen from both sides of the picture holder.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

1-2. (canceled)

3. A picture holder capable of holding pictures, posts, or photos comprising:
a stable supporting device including two downwardly and outwardly extended flaps, and an upper panel coupled between the upper portion of the flaps, to from an inverted U shaped stable supporting structure; and
a loose-leaf binder device engaged onto the upper panel of the supporting device, and secured to the upper panel of the supporting device with fasteners; the loose-binder device having a retaining strip which has a hollow space at a longitudinal direction; and at least one transversal slot; the loose-lead binder device further including at least one binder ring provided thereon; the at least binder ring passing through the at least transversal slot so as to be fixed to the retaining strip; the binder ring serving for detachable or changeably attaching pictures or posts or photos thereon.
